(19) United States
(12) Patent Application Publication
(10) Pub. No.: US 2012/0262024 A1
(43) Pub. Date: Oct. 18, 2012

(54) Squirrel-Cage Rotor And Method For Producing Such A Squirrel-Cage Rotor

(75) Inventors: George Kleynhans, Buelach (CH); Uwe Lauber, Laufenburg (DE); Peter Ortmann, Schaffhausen (CH); Roger Suter, Zuerich (CH)

(73) Assignee: MAN Diesel & Turbo SE, Augsburg (DE)

(21) Appl. No.: 13/496,154

(22) PCT Filed: Jul. 15, 2010
(86) PCT No.: PCT/DE2010/050046

§ 371 Date: Jun. 22, 2012

(30) Foreign Application Priority Data
Sep. 15, 2009 (DE) 102009041564.5

(51) Int. Cl. H02K 17/16; H02K 15/02

(52) U.S. Cl. 310/211; 29/598

(57) ABSTRACT

Squirrel cage rotor and method for the production thereof including a rotor shaft having a solid rotor portion formed of ferromagnetic material having a plurality of through-passages extending in an axial direction of the rotor shaft, a plurality of electrically conducting bar elements each received in a through-passage so that the respective bar elements extend in the axial direction. The bar elements each have a first longitudinal end and a second longitudinal end, and two electrically conducting end elements which electrically connect the longitudinal ends to form a squirrel cage is formed by the bar elements and end elements. The bar elements are received in the through-passages in such that relative movement in the axial direction between the solid rotor portion and the bar elements is enabled when there is a change in length of the bar elements and/or of the solid rotor portion.

### CROSS REFERENCE TO RELATED APPLICATIONS

This is a U.S. national stage of application No. PCT/DE2010/05046, on 15 Jul. 2010. Priority is claimed on German Application No. 102009041564.5, filed 15 Sep. 2009, the content of which is incorporated here by reference.

### BACKGROUND OF THE INVENTION

1. Field of the Invention

The invention is directed to a squirrel cage rotor and to a method for producing a squirrel cage rotor.

2. Detailed Description of Related Art

Laminated rotors for electric motors, i.e., rotators which are built from many individual ferromagnetic plates, are known.

For applications having very high rotational speeds and/or in contaminated, corrosive or uncontrollable environments laminated construction can be subject to physical limits or can even become unacceptable.

The use of a one-part, solid rotor of ferromagnetic material can offer the desired solution because this constructional form presents substantial advantages with respect to mechanical strength, rotordynamic stability, simplicity of construction, and huge reduction in structural component parts.

Various constructional types of solid rotors are realized and used in the prior art such as, e.g., plain solid rotors, solid rotors with slots, solid rotors with outer sleeves, solid rotors with short circuited cages, and so on.

A short circuited rotor, or squirrel cage rotor, of an electric motor can typically have a ferromagnetic rotor shaft with a solid rotor portion, a plurality of electrically conducting bar-shaped conductors and electrically conducting end rings.

A squirrel cage rotor of the type mentioned in the introductory part is known from DE 7000062 U. In this squirrel cage rotor, a plurality of conical conductor bars (bar elements) are inserted by shrinkage in conical bores (through-passages) extending axially through a solid rotor portion of the squirrel cage rotor. In other words, the conductor bars are fixedly connected to the solid rotor portion. Accordingly, when the squirrel cage rotor heats up, the squirrel cage rotor can warp because the conductor bars are generally fabricated from a different material than the solid rotor portion and therefore have different thermal expansion characteristics. This warping can lead to imbalances or even to cracks.

This construction can result in a reduced life of the squirrel cage rotor and premature failure of an electric motor outfitted with this squirrel cage rotor.

### SUMMARY OF THE INVENTION

It is an object of the invention to provide a squirrel cage rotor exhibiting less warping in operation. The invention further provides a method for the production of a squirrel cage rotor of this kind.

According to one embodiment of the invention, a squirrel cage rotor for an electric motor has a rotor shaft having a solid rotor portion formed of ferromagnetic material which has a plurality of through-passages extending in an axial direction of the rotor shaft so as to be distributed around a circumference of the solid rotor portion, a plurality of electrically conducting bar elements are each received in one of the through-passages so that the respective bar elements extend through the solid rotor portion in axial direction of the rotor shaft. The bar elements each have a first longitudinal end and a second longitudinal end remote of the first longitudinal end, and two electrically conducting end elements. A first end element electrically connects the first longitudinal ends of the bar elements to one another, and a second end element electrically connects the second longitudinal ends of the plural bar elements to one another so that a short circuited cage, or squirrel cage, is formed by the bar elements and end elements.

The squirrel cage rotor according to one embodiment of the invention is characterized in that the respective bar elements are received in the through-passages in such a way that a relative movement in axial direction of the rotor shaft between the solid rotor portion and the respective bar elements received in the through-passages of the solid rotor portion is enabled when there is a change in length of the bar elements and/or of the solid rotor portion.

Owing to the fact that a relative movement in axial direction of the rotor shaft is enabled between the solid rotor portion and the bar elements when there is a change in length of the bar elements and/or of the solid rotor portion, e.g., caused by heating, the solid rotor portion and therefore the entire squirrel cage rotor operating in an electric motor does not warp as extensively as a conventional squirrel cage rotor or does not warp at all.

In this way, imbalances and cracks which would result in a shortened life of the squirrel cage rotor and therefore in premature failure of an electric motor outfitted with this squirrel cage rotor can be prevented.

The solid rotor portion is preferably formed integrally with the rotor shaft so that the rotor shaft and solid rotor portion are produced from the same material.

This construction has the advantage that no frictional engagement and/or positive engagement is required between the rotor shaft and solid rotor portion; rather, both can be produced from one piece, e.g., by turning. This reduces production costs and possible problems with the squirrel cage rotor.

According to the invention, the respective bar elements can be received in the through-passages in such a way that the bar elements are displaceable in axial direction relative to the solid rotor portion by overcoming a determined force. A bearing support of the bar elements in the through-passages of this kind can be realized by a slight interference fit, a transition fit, a clearance fit, or even in that the bar elements are received in the through-passages with a looseness exceeding that of a clearance fit.

The respective bar elements are preferably received in the through-passages without clamping so as to enable an uninhibited relative movement in axial direction of the rotor shaft between the solid rotor portion and the respective bar elements received in the through-passages thereof. Preferably, a clearance fit is formed between an outer circumference of the respective bar elements and an inner circumference of the respective through-passages.

Accordingly, on the one hand, the bar elements are uninhibitedly displaceable relative to the solid rotor portion and, on the other hand, can be exchanged simply and quickly should this be necessary.

During operation of an electric motor, e.g., an asynchronous machine, which is outfitted with the squirrel cage rotor according to the invention, the bar elements are pressed against a radially outer portion of their respective through-passage to an increasing extent as the rotational speed increases so that the bar elements are prevented from vibrating and the magnetic flux is improved. This reduces heating of the solid rotor portion and bar elements.

According to one embodiment of the invention, at least one of the first longitudinal end and second longitudinal end of each bar element is connected to the associated end element in such a way that a relative movement in axial direction of the rotor shaft is enabled between the respective longitudinal end and the end element when there is a change in length of the respective bar element and/or of the solid rotor portion while ensuring an electrical connection which is dimensioned for an electrical current to be transmitted.

In other words, on the one hand, the respective longitudinal end is held, e.g., clamped or, e.g., connected by a screw/compression spring combination, to the end element firmly enough that the bar element cannot accidently disengage from the through-passages during operation of the squirrel cage rotor and the maximum induction current (eddy current) to be transmitted can always be transmitted via this connection. On the other hand, when there is a change in length of the bar element and/or of the solid rotor, e.g., due to heating, it is possible for the respective longitudinal end to displace in axial direction relative to the end element by overcoming a determined force so as to compensate for the change in length.

Warping of the solid rotor portion or of the entire squirrel cage rotor is reliably prevented in this way.

According to one embodiment of the invention, the end elements can have pocket recesses and/or through-recesses for receiving the longitudinal ends of the bar elements. When pocket recesses are used, it must be ensured that there is sufficient clearance between a bottom portion of the respective pocket recess and the respective longitudinal end so that the length expansion of the bar element can be accommodated.

According to one embodiment of the invention, both longitudinal ends can be received in both end elements as described above so as to be axially displaceable.

According to one embodiment of the invention, a transition fit is formed between the respective displaceable longitudinal end and the respective associated end element.

On the one hand, the transition fit ensures that the respective longitudinal end is held at the end element sufficiently firmly so that the bar element cannot accidently disengage from the through-passages during operation of the squirrel cage rotor, and the maximum induction current (eddy current) to be transmitted can always be transmitted via this connection and, on the other hand, so that the respective longitudinal end displaces in axial direction relative to the end element when there is a change in length of the bar element and/or of the solid rotor, e.g., due to heating, by overcoming a determined force (in this instance, a clamping force generated by the transition fit) so that the change in length is compensated.

According to one embodiment of the invention, the end elements are constructed annularly in each instance, every end element being formed of at least two parts, and the at least two parts of every end element being electrically connected to one another.

The multiple-part, e.g., two-part or three-part, construction of the end element facilitates assembly thereof because the quantity of bar elements to be fitted simultaneously, or per part, is reduced. Therefore, less exacting tolerances can be selected with respect to manufacturing precision (e.g., angular pitch, diameter of the through-passages), thereby reducing costs.

According to another embodiment form of the invention, a squirrel cage rotor is provided with a solid rotor portion having a squirrel cage, wherein the squirrel cage rotor has a ferromagnetic rotor shaft with the solid rotor portion formed integral therewith, a plurality of electrically conducting bar elements (bar-shaped conductors) and electrically conducting end elements (preferably end rings) formed of one or more parts, and wherein the bar elements are introduced into drilled or eroded holes in the solid rotor portion of the rotor shaft.

According to one embodiment of the invention, the bar elements can have a round, oval, angular, or any other profile cross section.

According to one embodiment of the invention, the bar elements are loosely or fixedly connected to the end elements (preferably end rings) formed of one or more parts.

According to one embodiment of the invention, the bar elements are loosely connected to the solid rotor portion which is formed integrally with the ferromagnetic rotor shaft.

According to one embodiment of the invention, in a method for producing a squirrel cage rotor according to one or more or all of the above-described embodiments in any conceivable combination, the through-passages in the solid rotor portion are each introduced into the solid rotor portion by separating machining.

Accordingly, the desired fit between respective bar elements and respective through-passages can be ensured with good accuracy on the one hand and the bar elements can reliably pass into the end elements with good positioning accuracy on the other hand.

The through-passages in the solid rotor portion are preferably introduced in the solid rotor portion by cutting machining and/or material removing machining. Still more preferably, the through-passages in the solid rotor portion are introduced in the solid rotor portion by boring and/or electrical discharge erosion.

In other words, according to one embodiment of the method, the introduction of bar elements (bar-shaped conductors) is realized by deep hole boring and/or form erosion at the circumference through the solid rotor portion, i.e., through the preferably solid-walled or solid rotor shaft having the portion provided for the solid rotor.

### BRIEF DESCRIPTION OF THE DRAWINGS

The invention will be described in more detail in the following with reference to a preferred embodiment form and accompanying drawings.

FIG. 1 is a schematic partial sectional view of a squirrel cage rotor according to one embodiment of the invention; and

FIG. 2 is a cross-sectional view of a solid rotor portion of the squirrel cage rotor of FIG. 1 viewed along a line A-A in FIG. 1.

### DETAILED DESCRIPTION OF THE PREFERRED EMBODIMENTS

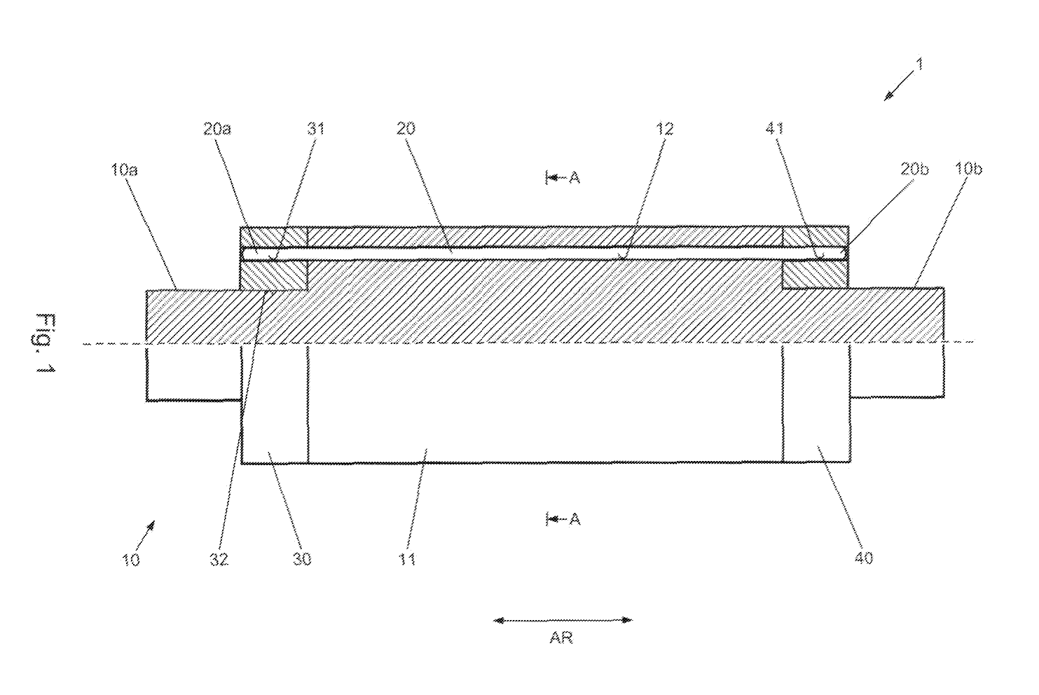

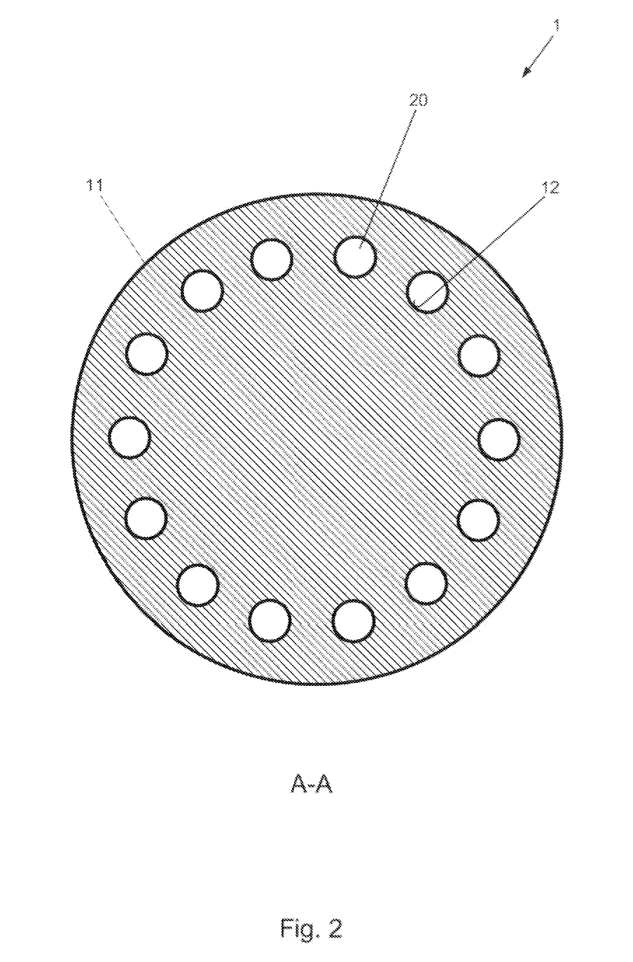

As is shown in FIG. 1 and FIG. 2, a squirrel cage rotor 1 according to one embodiment of the invention for an electric motor (not shown in its entirety) has a rotor shaft 10 which is formed of ferromagnetic material and which has a solid rotor portion 11 formed integrally therewith in the form of a cylindrical diametrical enlargement, a plurality of electrically conducting bar elements 20 having a circular cross section of constant diameter, and two electrically conducting end elements 30 and 40 in the form of two end rings, each formed of one part.

The solid rotor portion 11 has a plurality of through-passages 12 extending in an axial direction AR of the rotor shaft 10 so as to be distributed around the circumference of the solid rotor portion 11.

The bar elements 20 are received, respectively, in one of the through-passages 12 so that the respective bar elements 20 extend in axial direction AR of the rotor shaft 10 through the solid rotor portion 11, each bar element 20 having a first longitudinal end 20a and a second longitudinal end 20b remote of the first longitudinal end 20a.

A first end element 30 (on the left-hand side in FIG. 1) of the two end elements 30, 40 electrically connects the first longitudinal ends 20a of the bar elements 20 to one another. A second end element 40 (on the right-hand side in FIG. 1) of the two end elements 30, 40 electrically connects the second longitudinal ends 20b of the bar elements 20 to one another. In this way, the bar elements 20 and the two end elements 30, 40 form a squirrel cage.

The respective bar elements 20 are received in the through-passages 12 such that a relative movement in axial direction AR of the rotor shaft 10 between the solid rotor portion 11 and the respective bar elements 20 received in the through-passages 12 thereof is enabled when there is a change in length of the bar elements 20 and/or of the solid rotor portion 11, e.g., caused by heating.

According to one embodiment, the respective bar elements 20 are received in the through-passages 12 without clamping so as to enable an unobstructed relative movement in axial direction AR of the rotor shaft 10 between the solid rotor portion 11 and the respective bar elements 20 received in the through-passages 12 thereof; that is, substantially no clamping force need be overcome for the movement or displacement of the bar elements 20 in the through-passages 12.

To this end, a clearance fit, i.e., a fit in which both parts have the same nominal dimension but have tolerance ranges which differ in such a way that the smallest inner diameter of the through-passage 12 is always greater than the greatest outer diameter of the bar element 20, is formed between an outer circumference (not shown) of the respective bar elements 20 and an inner circumference (not shown) of the respective through-passages 12.

Each end element 30, 40 has a plurality of through-bore holes 31 and 41, respectively, which are arranged so as to be distributed around a circumference of the end element 30, 40 and whose circular pitch corresponds to that of the through-passages 12. Further, each end element 30, 40 has a central receiving bore hole 32 and 42, respectively.

The central receiving bore hole 32 of the first end element 30 is fitted onto a first longitudinal end 10a of the rotor shaft 10 and is connected to the solid rotor portion 11 by a screw connection (not shown). The first longitudinal ends 20a of the bar elements 20 are inserted into the through-bore holes 31 of the first end element 30. A slight interference fit, i.e., a fit in which both parts have the same nominal dimension but have tolerance ranges which differ in such a way that the greatest inner diameter of the through-bore hole 31 is always smaller than the smallest outer diameter of the bar element 20, is formed between the outer circumference of the respective bar elements 20 and an inner circumference (not shown) of the respective through-bore holes 31.

The first longitudinal end 20a of each bar element 20 is additionally secured against disengagement from the through-bore hole 31 by a headless screw, not shown, engaging in the through-bore hole 31 from radially outward of the end element 30 to radially inward thereof.

The central receiving bore hole 42 of the second end element 40 is fitted onto a second longitudinal end 10b of the rotor shaft 10 and is connected to the solid rotor portion 11 by a screw connection (not shown). The second longitudinal ends 20b of the bar elements 20 are inserted into the through-bore holes 41 of the second end element 40. A transition fit tending toward an interference fit, i.e., a fit with a slight overdimension of the outer diameter of the bar element 20 relative to the inner diameter of the through-bore hole 41, is formed between the outer circumference of the respective bar elements 20 and the inner circumference of the respective through-bore holes 41.

In contrast to the first longitudinal end 20a, the second longitudinal end 20b of every bar element 20 is not additionally secured by a headless screw.

Therefore, the second longitudinal end 20b of every bar element 20 is connected to the associated second end element 40 in such a way that a relative movement in axial direction AR of the rotor shaft 10 between the second longitudinal end 20b and the second end element 40 is enabled when there is a change in length of the respective bar element 20 and/or of the solid rotor portion 11, e.g., due to heating, while ensuring an electrical connection which is dimensioned for an electrical current to be transmitted.

In other words, the second longitudinal ends 20b of the bar elements 20 can displace in axial direction AR relative to the second end element 40 by overcoming a determined force (in this case, a slight clamping force generated by the transition fit) so that the change in length is compensated and no tensions, and therefore also no warping, occur in the squirrel cage rotor 1.

According to one embodiment of a method according to the invention for producing the squirrel cage rotor 1, the through-passages 12 in the solid rotor portion 11 are introduced in each instance by separating machining in the solid rotor portion 11.

More precisely stated: the through-passages 12 in the solid rotor portion 11 are each introduced in the solid rotor portion 11 by cutting machining and/or material removing machining, in this case particularly by deep hole boring (e.g., by a horizontal boring mill) and/or electrical discharge erosion.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A squirrel cage rotor for an electric motor comprising:
a rotor shaft having a solid rotor portion formed of ferromagnetic material having a plurality of through-passages distributed around a circumference of the solid rotor portion extending in an axial direction of the rotor shaft;
a plurality of electrically conducting bar elements which are each received in a respective one of the plural through-passages so that the respective bar elements extend through the solid rotor portion in the axial direction of the rotor shaft, each of the plural bar elements having a first longitudinal end and a second longitudinal end remote of the first longitudinal end; and
two electrically conducting end elements, a first end element electrically connects the first longitudinal ends of the plural bar elements to one another, and a second end element electrically connects the second longitudinal ends of the bar elements to one another so that a squirrel cage is formed by bar elements and the two end elements,
wherein the respective bar elements are received in respective through-passages such that a relative movement in the axial direction of the rotor shaft between the solid rotor portion and the respective bar elements received in the through-passages of the solid rotor portion is enabled when there is a change in length of at least one of the plural bar elements and of the solid rotor portion.

11. The squirrel cage rotor according to claim 10, wherein the respective bar elements are received in the respective through-passages without clamping so as to enable relative movement in the axial direction of the rotor shaft between the solid rotor portion and the respective bar elements received in the through-passages.

12. The squirrel cage rotor according to claim 10, wherein a clearance fit is formed between an outer circumference of the respective bar elements and an inner circumference of the respective through-passages.

13. The squirrel cage rotor according to claim 10, wherein one of the first and second longitudinal ends of every bar element is connected to the associated end element such that a relative movement in the axial direction of the rotor shaft between the respective longitudinal end and the end element is enabled when there is a change in length of at least one of the respective bar element and of the solid rotor portion while ensuring an electrical connection which is dimensioned for an electrical current to be carried.

14. The squirrel cage rotor according to claim 13, wherein a transition fit is formed between a displaceable longitudinal end and the respective associated end element.

15. The squirrel cage rotor according to claim 14, wherein the end elements are each constructed annularly, and wherein each end element is formed of at least two parts, and wherein the at least two parts of each end element are electrically connected to one another.

16. A method for producing a squirrel cage rotor comprising:
forming a rotor shaft of ferromagnetic material having a plurality of through-passages distributed around a circumference of the solid rotor portion extending in an axial direction of the rotor shaft; and
receiving a plurality of electrically conducting bar elements in a respective one of the plural through-passages so that the respective bar elements extend through the solid rotor portion in the axial direction of the rotor shaft, each of the plural bar elements having a first longitudinal end and a second longitudinal end remote of the first longitudinal end,
wherein the through-passages in the solid rotor portion are introduced in the solid rotor portion in each instance by separating machining.

17. The method according to claim 16, wherein the through-passages in the solid rotor portion are each introduced in the solid rotor portion by at least one of cutting machining and material removing machining.

18. The method according to claim 17, wherein the through-passages in the solid rotor portion are introduced in the solid rotor portion by at least one of boring and electrical discharge erosion.

19. The squirrel cage rotor according to claim 11, wherein a clearance fit is formed between an outer circumference of the respective bar elements and an inner circumference of the respective through-passages.
